(19) United States
(12) Patent Application Publication
(10) Pub. No.: US 2007/0219660 A1
(43) Pub. Date: Sep. 20, 2007

(54) Substrate transporting and processing apparatus, fault management method for substrate transport and processing apparatus, and storage medium storing fault management program

(76) Inventors: Tomohiro Kaneko, Koshi-Shi (JP); Akira Miyata, Koshi-Shi (JP)

Correspondence Address: Smith, Gambrell & Russell, Suite 800, 1850 M Street, N.W., Washington, DC, 20036, US

(21) Appl. No.: 11/600,905

(22) Filed: Nov. 17, 2006

(30) Foreign Application Priority Data
Nov. 24, 2005 (JP) 2005-337954

(51) Int. Cl. G06F 19/00

(52) U.S. Cl. 700/100; 700/121

(57) ABSTRACT

Disclosed is a countermeasure to be taken when a fault occurs in one of process modules 11-17 or a transport module 20 that makes it impossible to transport substrates to a process module positioned downstream of a post-exposure baking module 15 in accordance with a predetermined transport schedule in a post-exposure substrate transport path that starts from an exposure apparatus 5 and goes through the post-exposure baking (PEB) module 15, a developing module 12, and a post-development baking module 15. In this instance, part of post-exposure processes to a post-exposure baking process are continuously performed to the exposed substrates and the wafers W having been subjected to the PEB process are loaded into a buffer module 32 and temporarily stored in the buffer module 32 until the fault is cleared. This prevents increase in the time period from an exposure process completion to the post-exposure baking process even when the fault occurs, thereby avoiding defective line width the circuit pattern of a resist, particularly a chemically amplified resist.

### TECHNICAL FIELD

The present invention relates to a substrate transporting and processing apparatus that includes plural sorts of process modules, which perform predetermined pre-exposure processes or post-exposure processes to a substrate, such as a semiconductor wafer or an LCD glass substrate, and a transport system, which has at least one transport module for transporting the substrate between the process modules. More particularly, the present invention relates to countermeasures against a fault which may occur in any one of the modules and which might adversely affect the substrate quality

### BACKGROUND ART

In processing of a substrate such as a semiconductor wafer or a LCD (Liquid Crystal Display) substrate, photolithography technique is generally employed to form an ITO (Indium Tin Oxide) thin film and an electrode pattern on the substrate. Photolithography includes a process for applying a photoresist to the substrate, a process for exposing a resist, a process for developing the resist and so on. A processing system, which is a combination of a resist coating and developing apparatus and an exposure apparatus, is used to perform the above-mentioned processes.

The resist coating and developing apparatus is usually configured as a substrate transporting and processing apparatus that includes plural sorts of process modules for performing the above-mentioned processes, and a transport system including plural transport modules for transporting substrates between the process modules. A wafer removed from a cassette containing plural unprocessed substrates is transported through process modules in a pre-exposure substrate transport path, and is loaded into an exposure apparatus. The exposed wafer is transported through process modules in a post-exposure substrate transport path, and is placed in a cassette for processed substrates. As regards a conventional resist coating and developing apparatus, the number of process modules for each process is determined so as to maximize the throughput of the whole processing system, in view of the time required for each process, that is, the throughput of each process module. There are provided plural process modules each for performing a process requiring a long process time; substrates are sequentially loaded into those process modules and processed therein at predetermined time intervals. This processing style is called “distributed processing” or “parallel processing.”

Japanese Patent Laid-Open Publication No. JP11-16983A (Document 1) discloses a substrate transporting and processing apparatus, in which, if one of plural process modules of the same kind fails (i.e., fault occurs), substrates are thereafter loaded only into normal (not faulty) one of the process modules. This operation advantageously prevents complete stop of the substrate transporting and processing apparatus, although the substrate transporting and processing schedule are delayed after the occurrence of the fault. A similar technique is disclosed in JP9-50948A (Document 2).

However, if a substrate transport operation is delayed in a resist coating and developing apparatus, the resulting resist pattern may be adversely affected. In a case where a chemically-amplified resist is used, the time from an exposure process to a post-exposure baking process must be fixed, otherwise a desired circuit pattern line width cannot be obtained. Therefore, if the countermeasure described in Document 1 is taken in a situation where a process module positioned downstream of a post-exposure bake module is faulty, a desired circuit pattern line width is not likely to be obtained.

### DISCLOSURE OF THE INVENTION

The present invention has been made in view of the above circumstances. It is an object of the present invention to provide a technique that increases the product yield rate by maintaining the time from completion of an exposure process to starting of a baking process constant even if a fault occurs in a process module.

In order to achieve the objective, according to a first aspect of the present invention, there is provided a substrate transporting and processing apparatus that is connectable to an exposure apparatus and is configured to perform predetermined pre-exposure processes and predetermined post-exposure processes on substrates, the apparatus including: a plurality of process modules adapted to perform the predetermined pre-exposure processes and the predetermined post-exposure processes, and including a process module for performing a post-exposure baking (PEB) process as one of the post-exposure processes; a transport system including at least one transport module and configured to sequentially transport substrates to process modules for the pre-exposure process in accordance with a predetermined pre-exposure substrate transport path, transfer the substrates to the exposure apparatus, and sequentially transport exposed substrates to process modules for the post-exposure processes in accordance with a predetermined post-exposure substrate transport path; a buffer module configured to contain a plurality of substrates and disposed so as to allow substrate to be transferred between the buffer module and the transport system; and a controller configured to control operations of the plurality of process modules and the transport system in accordance with a predetermined substrate transport schedule and a predetermined substrate processing schedule, and configured to detect a fault that may occur in the plurality of process modules and the transport system, wherein the controller is configured so that: when the controller detects a fault in the process module or the transport system that makes it impossible to transfer substrates, in accordance with the predetermined transport schedule, to a process module positioned downstream of the process module for performing the PEB process in the post-exposure substrate transport path, the controller controls the process module and the transport system so that exposed substrates are continuously subjected to processes to the PEB process included in the post-exposure processes, and so that at least part of the substrates having been subjected to the PEB process are loaded into the buffer module for temporary storage.

Further, according to a second aspect of the present invention, there is provided a fault management method for use in a substrate transporting and processing apparatus, the apparatus being connectable to an exposure apparatus and being configured to perform predetermined pre-exposure processes and predetermined post-exposure processes on substrates, the transporting and processing apparatus being provided with a plurality of process modules adapted to perform the predetermined pre-exposure processes and the predetermined post-exposure processes, and including a process module for performing a post-exposure baking (PEB) process as one of the post-exposure processes, and the transporting and processing apparatus also being provided with a transport system including at least one transport module and configured to sequentially transport substrates to process modules for the pre-exposure process in accordance with a predetermined pre-exposure substrate transport path, transfer the substrates to the exposure apparatus, and sequentially transport exposed substrates to process modules for the post-exposure processes in accordance with a predetermined post-exposure substrate transport path, the method including the steps of: detecting a fault in the process module or the transport system that makes it impossible to transfer substrates, in accordance with the predetermined transport schedule, to a process module positioned downstream of a process module for performing the PEB process in the post-exposure substrate transport path; and upon detection of the fault, continuously performing processes to the PEB process included in the post-exposure processes to exposed substrates, and loading at least part of the substrates having been subjected to the PEB process into the buffer module for temporary storage.

Further, according to a third aspect of the present invention, there is provided a storage medium storing a computer-readable fault management program for executing a fault management method for use in a substrate transporting and processing apparatus, the apparatus being connectable to an exposure apparatus and being configured to perform predetermined pre-exposure processes and predetermined post-exposure processes on substrates, the transporting and processing apparatus being provided with a plurality of process modules adapted to perform the predetermined pre-exposure processes and the predetermined post-exposure processes, and including a process module for performing a post-exposure baking (PEB) process as one of the post-exposure processes, the transporting and processing apparatus also being provided with a transport system including at least one transport module and configured to sequentially transport substrates to process modules for the pre-exposure process in accordance with a predetermined pre-exposure substrate transport path, transfer the substrates to the exposure apparatus, and sequentially transport exposed substrates to process modules for the post-exposure processes in accordance with a predetermined post-exposure substrate transport path, the transporting and processing apparatus also being provided with a control computer that controls the operations of the plurality of process modules and the transport system, wherein upon execution of the fault management program, the control computer controls the substrate transporting and processing apparatus to execute the fault management method according to the second aspect of the present invention.

The present invention makes it possible to avoid increase in the time interval from the exposure process completion to the post-exposure baking (PEB) process and decrease in the product yield rate even when a process module becomes faulty.

### BRIEF DESCRIPTION OF DRAWINGS

FIG. 1 is a plan view schematically showing the configuration of a resist coating, exposing and developing system, which is constituted by combining a resist coating and developing apparatus in one embodiment of a substrate transporting and processing apparatus according to the present invention and an exposure apparatus.

FIGS. 2 and 3 are charts illustrating how wafers are transported when a coating module of the resist coating and developing apparatus becomes faulty, wherein the greater the drawing number, the later the indicated state.

FIGS. 4 and 12 are charts illustrating how wafers are transported when the coating module is restored, wherein the greater the drawing number, the later the indicated state.

### BEST MODE FOR CARRYING OUT THE INVENTION

An embodiment of the present invention will now be described in detail with reference to the accompanying drawings. In the below illustrated embodiment, the substrate transporting and processing apparatus according to the present invention is configured as a resist coating and developing apparatus that applies a chemically-amplified resist to substrates (in this embodiment, semiconductor wafers) and performs a development process to exposed substrate. The resist coating and developing apparatus is connected to an exposure apparatus (5) to constitute a resist coating, exposing and developing system (hereinafter referred to as “processing system”).

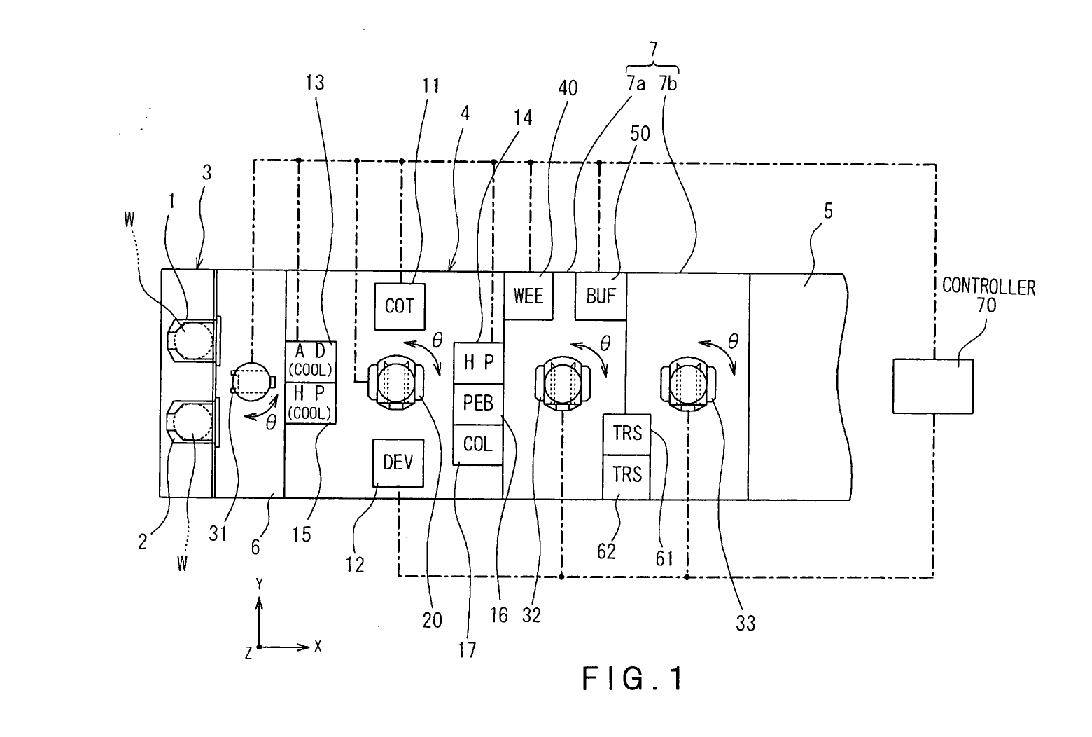

As shown in FIG. 1, the processing system includes: a loading/unloading section 3 that allows a cassette 1 for loading (loading cassette) for containing therein plural semiconductor wafers W (hereinafter referred to as “wafers W”) and a cassette 2 for unloading (unloading cassette) for containing plural processed wafers W to be disposed side by side; a processing section 4 provided therein with plural process modules that perform predetermined processes to wafers W; an exposure apparatus 5; a first interface section 6 disposed between the loading/unloading section 3 and the processing section 4; and a second interface section 7 disposed between the processing section 4 and exposure apparatus 5 and composed of two interface blocks, i.e., a main interface block 7a and an auxiliary interface block 7b.

Provided in the processing section 4 are: a plurality of coating modules 11 stacked at multiple levels on one side of the processing section 4 that apply a resist to the wafers W; and a plurality of developing modules 12 stacked at multiple levels on the other side of the processing section 4 that perform a development process to exposed wafers W. Provided in the processing section 4 adjacent to the interface section 6 are: adhesion modules 13 stacked at multiple levels that perform a hydrophobizing process to wafers W; and second hot plate modules 15 stacked at multiple levels that perform a baking process to developed wafers W. Provided in the processing section 4 adjacent to the interface section 6 are: first hot plate modules 14 stacked at multiple levels that perform a baking process to wafers W coated with the resist; post-exposure bake modules 16 (hereinafter referred to as “PEB modules”) stacked at multiple levels that heat exposed wafers W in order to induce acid-catalyzed reaction of the chemically amplified resist; and cooling modules 17 stacked at multiple levels that cools wafers W in order to stop the acid-catalyzed reaction. Cooling modules (17) may be provided in the PEB modules 16 instead of separately providing the cooling modules 17 as shown in FIG. 1. In this case, the PEB modules 16 are configured so that the wafers W can be transferred between the PEB modules 16 and the cooling modules (17). Further, it is preferable that a high-precision temperature control module be provided to accurately control the temperature of the wafers W, having been cooled by the cooling modules, at an optimal temperature for a development process

A main transport module 20 is disposed at the center of the processing section 4 to transfer wafers W to and from the coating modules 11, developing modules 12, adhesion modules 13, first and second hot plate modules 14 and 15, PEB modules 16, and cooling modules 17. The main transport module 20 has a transport arm that can move in horizontal directions (X and Y directions) and vertical direction (Z direction) and rotate about a vertical axis (in θ direction).

The first interface section 6 includes a first transport module 31, which transfers wafers W to and from the cassettes 1 and 2 placed in the loading/unloading section 3. The first transport module 31 has a transport arm that can move in a horizontal direction (X and Y directions) and vertical direction (Z direction) and rotate about a vertical axis (in θ direction).

Provided in the main interface block 7a of the second interface section 7 are: an edge exposure module 40 that exposes the peripheral portion of a wafer W coated with the resist in order to remove the resist form the peripheral portion of wafer W; a buffer module 50 that allows plural wafers W to temporarily stand by therein; and a second transport module 32 that transfers wafers W to and from the edge exposure module 40, buffer module 50, first and second transfer modules 61, 62 which will be described later, PEB modules 16, and cooling modules 17 (if the cooling modules are not built in the PEB modules 16). The second transport module 32 has a transport arm that can move in horizontal directions (X and Y directions) and vertical direction (Z direction) and rotate about a vertical axis (in θ direction).

Plural first transfer modules 61 and plural second transfer modules 62 are stacked at multiple levels at the boundary between the main interface block 7a and auxiliary interface block 7b. It is preferable that the first transfer modules 61 can function as a cooling module.

The auxiliary interface block 7b is provided therein with a third transport module 33, which transports wafers W between the first transfer modules 61 or the second transfer modules 62 and the exposure apparatus 5. The foregoing main transport module 20 and first to third transport modules 31 to 33 constitute a transport system in the processing system.

In the processing system, the coating modules 11, developing modules 12 and various other process modules, the main transport module 20, the first to third transport modules 31 to 33, and all other functional modules are electrically connected to a controller 70, which is provided in the form of a control computer that exercises overall control of the operation of the processing system. The controller 70 can communicate necessary data with the exposure apparatus 5. Installed in a storage medium of the controller 70 which is typically a hard disk drive is control data necessary for overall control of the processing system such as control programs for executing a wafer transport schedule, a wafer processing schedule and selecting or switching (changing) of these schedules. The control data may be supplied, with the control data being stored in any storage medium (DVD-ROM, memory card, etc.) that is publicly known in the field of computer technology. The controller 70 is configured to detect a fault that occurs in each modules and the elimination of such a fault. When a fault occurs, the controller 70 performs a special wafer protection procedure, which will be described later, by executing a fault management program installed in the storage medium.

[Procedures in the Normally-Operating Processing System]

In the processing system, the controller 70 sends control signals, generated through execution of the foregoing control program, to the modules. In accordance with the received control signals, the modules perform predetermined procedures. The operations performed by the processing system during a normal operation (when no fault occurs) will be described below.

First of all, the first transport module 31 in the first interface section 6 removes an unprocessed wafer W from the loading cassette 1 and transports it to the adhesion module 13. The wafer W is then hydrophobized by the adhesion module 13. Next, the main transport module 20 in the processing section 4 removes the wafer W from the adhesion module 13 and loads it into one of plural (in this embodiment, two) coating modules 11. A resist having a predetermined film thickness is coated on the surface of the wafer W by the coating module 11. Note that, in a case where there are plural process modules of the same type, each wafer W is loaded into a designated one of the process modules which is previously determined by the aforementioned transport schedule and processing schedule. Under normal operation, the plural process modules of the same type are used sequentially (i.e., distributed processing or parallel processing).

Next, the main transport module 20 unloads the wafer W coated with the resist from the coating module 11 and loads it into one of the plural (in this embodiment, three) first hot plate modules 14. The wafer W is subjected to a pre-baking process in the first hot plate module 14 at a predetermined temperature (e.g., at 100° C.) for a predetermined period of time, thereby the remaining solvent is evaporated to be removed from the resist film on the wafer W.

After completion of the pre-baking, the wafer W in the first hot plate module 14 is removed by the second transport module 32 in the main interface block 7a, and loaded into the edge exposure module 40. The peripheral portion of the wafer W is subjected to an edge exposure process.

After completion of the edge exposure process, the wafer W in the edge exposure module 40 is removed therefrom by the second transport module 32 and is transferred to the first transfer module 61. Next, the third transport module 33 in the auxiliary interface block 7b removes the wafer W from the first transfer module 61 and loads it into the exposure apparatus 5.

After an exposure process is performed by the exposure apparatus 5, the third transport module 33 receives the wafer W from the exposure apparatus 5 and transports the received wafer W to the second transfer module 62. Next, the second transport module 32 receives the wafer W from the second transfer module 62 and transports it to the PEB module 16. The wafer W is subjected to a post-exposure baking process (hereinafter referred to as “PEB process”) for a predetermined period of time in the PEB module 16. Acid-catalyzed reaction of the chemically amplified resist is then induced.

After the baking process is performed by the PEB module 16, the cooling module 17 performs a cooling process to stop the acid-catalyzed reaction. It is preferable that the transport of the wafer W from the PEB module 16 to the cooling module 17 is performed by the second transport module 32. If the cooling module (17) is built in the PEB module 16, a transport mechanism (not shown) built in the PEB module 16 transports the wafer to the cooling module (17). In this case, typically, a transport mechanism, in which a cooling plate capable of functioning as a cooling module is incorporated, is employed. For simplicity of the explanation, the description will be made assuming that the PEB module having a built-in cooling module is employed.

The main transport module 20 removes the cooled wafer W from the PEB module 16 and loads it into one of the plural (in this embodiment, two) developing modules 12. It is preferable that the temperature of the wafer W be precisely controlled by a high-precision temperature control module (not shown) before being loaded into the developing module 12. The developing module 12 applies a developer solution to the resist on the surface of the wafer W to perform a development process. After completion of the development, the developing module 12 pours a rinse solution onto the surface of the wafer W to remove the developer solution.

After the development process and rinse process are completed, the main transport module 20 unloads the wafer W from the developing module 12 and loads it into one of the plural second hot plate modules 15. The wafer W is subjected to a post-baking process for a predetermined period of time at a temperature, for instance, of 100° C. in the second hot plate modules 15. Thereby, the resist swollen by development process hardens to exhibit increased chemical resistance.

After completion of post-baking process, the first transport module 31 unloads the processed wafer W from the second hot plate module 15 and loads it into the unloading cassette 2. This completes a series of processes that is to be performed on a single wafer W in the processing system.

[Procedures when a Fault Occurs in the Processing System]

Next, the operation performed in the processing system when a module becomes faulty will be described. The present embodiment intends to save wafers W (i.e., prevent wafers W from becoming defective) wherever possible, when a module in the processing system, which performs a series of processes including chemically amplified resist application, exposure, and development, becomes faulty to increase the time interval between completion of the exposure process and completion of the PEB process. Therefore, it goes without saying that the present embodiment does not cover a case where the PEB module or the second transport module 32 is faulty.

“A fault of a module that may increase the time interval between completion of the exposure process and completion of the PEB process but may allow wafers to be saved” is “a fault of a process module or transport module that makes it impossible to transport a substrate to a process module positioned downstream of a process module for performing a PEB process in a post-exposure substrate transport path (i.e., a wafer transport path from the exposure apparatus 5 to the cassette 2) in accordance with a predetermined transport schedule.”

To be more precise, the above-mentioned fault in the processing system according to the present embodiment includes one of the following faults:

(Case 1) A fault that occurs in a process module (e.g., developing module 12 or second hot plate module 15) positioned downstream of a process module for performing a PEB process in the post-exposure substrate transport path;

(Case 2) A fault that occurs in a transport module (i.e., the main transport module 20) for loading or unloading a substrate into or from a process module positioned downstream of a process module for performing the PEB process in the post-exposure substrate transport path; and

(Case 3) A fault that occurs in a process module (e.g., the adhesion module 13, the coating module 11, or the first hot plate module 14) located in a pre-exposure substrate transport path (i.e., a wafer transport path from the cassette 1 to the exposure apparatus 5), the loading and unloading of a substrate into and from which is assigned to a transport module (i.e., the main transport module 20) that also takes charge of the loading and unloading of a substrate into and from a process module positioned downstream of a process module for performing the PEB process in the post-exposure substrate transport path.

Case 3 corresponds to “a fault of a process module or transport module that makes it impossible to transport a substrate to a process module positioned downstream of a process module for performing a PEB process”, because the main transport module 20 in this embodiment can perform only a transport operation in accordance with a predetermined transport schedule (hereinafter referred to as a “scheduled transport”). The term “scheduled transport” refers to a transport style in which the main transport module 20 assigned to the loading and unloading of a substrate to and from process modules accesses those process modules in a predetermined order whenever the main transport module 20 is operating. That is, whenever a fault occurs in any one of process modules the loading and unloading of a substrate into and from which is assigned to the main transport module 20, the main transport module 20 completely stops its operation; and the transport schedule of the main transport module 20 cannot be changed.

The definition of the terms “process module for performing the PEB process” and “PEB process” in this specification is as follows. The “PEB process” most commonly includes a series of steps in which a wafer W is heated to a temperature that induces the acid-catalyzed reaction of the chemically amplified resist, is maintained in such a baked state for a predetermined period of time, and then is cooled to stop the acid-catalyzed reaction. Therefore, in the processing system shown in FIG. 1, the “process module for performing the PEB process” means the PEB modules 16 and cooling module 17. If the cooling module is built in the PEB module, the “process module for performing the PEB process” means the PEB module. In a case where the PEB module has a built-in cooling module, even if there is provided downstream of the PEB module a high-precision temperature control module which may be deemed to be a cooling module, that cooling module is not deemed to be a “process module for performing the PEB process.” A slight degree of overbaking and an excessive heating time might not cause a problem in some cases, depending on the required line width accuracy or the temperature dependence of the acid-catalyzed reaction of the resist. In other words, the required line width accuracy may be attained even if the wafer W is not vigorously cooled by the cooling module after the heating of the wafer, or even if the wafer W is naturally cooled after the heating of the wafer W. Under such a situation, even if a process, which consists of a steps of heating of the wafer W at a temperature to induce the acid-catalyzed reaction of the chemically amplified resist and a step of maintaining such a heating condition until a predetermined period of time elapses, is considered as the “PEB process”, such a consideration is not against the spirits of the present invention. In this case, only the PEB module 16 corresponds to the “process module for performing the PEB process.” On the premise that the above is understood, the following description will be made assuming that the “process module for performing the PEB process” means the PEB module 16 and cooling module 17.

Note that the definitions of the above terms have been explained on the assumption that the resist is a chemically-amplified resist. However, regarding a resist other than the chemically-amplified resist, the above terms may be defined based on the same idea. That is, completion of the PEB process may be considered as completion of just the heating step of the wafer, or the completion of the cooling step of the wafer following the heating step, considering the expected chemical reaction of an exposed resist generated by the post-exposure baking process, and the required resist film quality (line width accuracy, etc.).

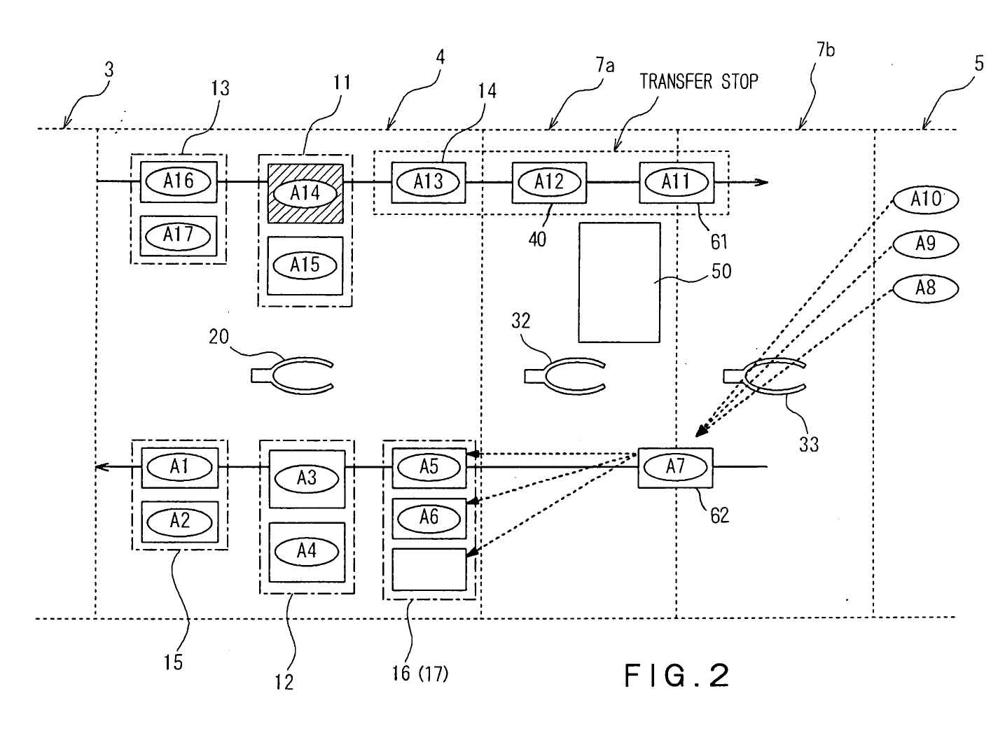

The operation performed in the foregoing “Case 3” will be described with reference to FIGS. 2 to 12. Here, it is scheduled that wafers W (A1 to A17) of processing lot A are firstly processed, and then wafers W (B1 to B17) of processing lot B are processed. It is assumed that a fault (failure) occurs in one of the two coating modules 11 (the coating module 11 that contains wafer W (A14) as shown in FIG. 2) when the wafers W (A1 to A17) of processing lot A are located in there respective positions in the processing system as shown in FIG. 2. Note that, as previously described, the description will be made assuming that the PEB modules 16 of a cooling module built-in type are employed, for simplicity of the explanation.

The controller 70, which monitors status signals generated by each process module and each transport module to indicate their status, recognizes that a fault has occurred in the coating module 11 based on the status signal received from the faulty coating module 11.

Based on the status signals, the controller 70 then recognizes the number of wafers W (A5 to A10) existing in a section from the exposure apparatus 5 to the PEB modules 16 at the point of time when the fault occurs. The number of wafers can also be recognized based on the transport schedule and processing schedule.

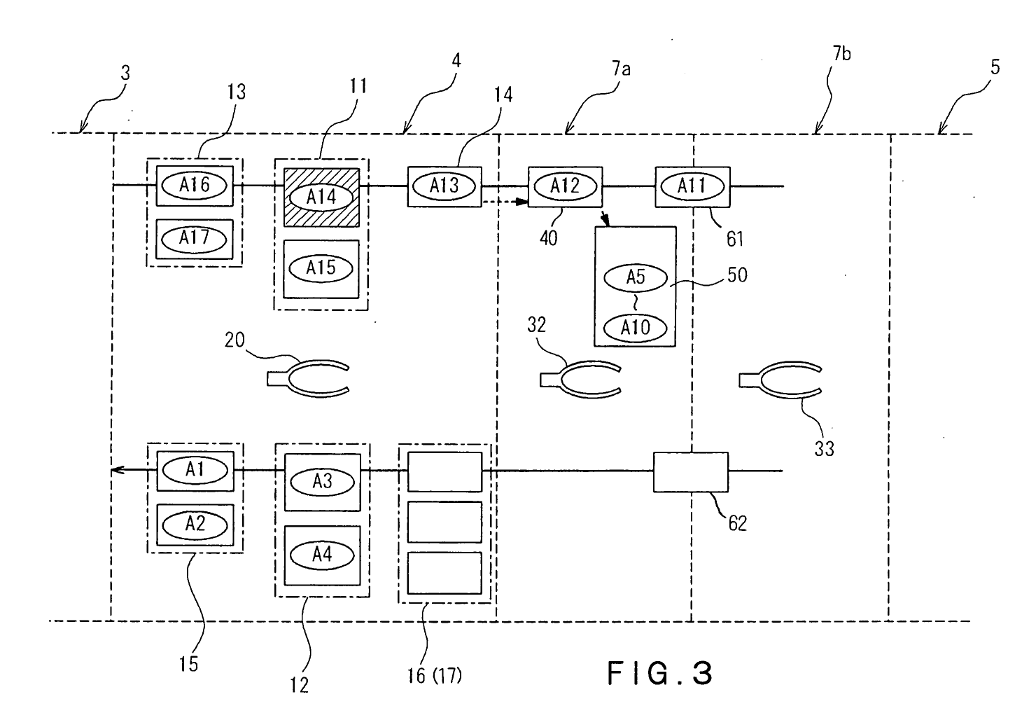

Regarding the wafers W (A5 to A10), the controller 70 controls the system so that processes to those wafers are continuously performed without changing their transport schedule and processing schedule for the time frame until those wafers W are transported into and processed in the PEB modules 16, so that those wafers W are sequentially subjected to processes to the PEB process (i.e., baking for inducing the acid-catalyzed reaction and cooling for stopping the acid-catalyzed reaction) performed in the PEB modules 16 with the built-in cooling module and that the processes to the PEB process to those wafers are completed. The controller also controls the system so that the wafers W (A5 to A10) having been subjected to the PEB process are then sequentially loaded into the buffer module 50 by means of the second transport module 32 (see FIG. 3). In this instance, the wafers W (A5 to A10) are carried into specified slots (not shown) in the buffer module 50. The controller 70 memorizes the addresses of the slots in which the wafers W (A5 to A10) are placed. This ensures that the time period from the exposure process completion to the PEB process completion for all the exposed wafers W (A5 to A10) remains the same as that under the normal operation, even when wafers cannot be transported to a process module positioned downstream of the PEB module 16 due to a fault in the coating module 11. Consequently, the line width of the circuit pattern eventually formed on the wafers W (A5 to A10) remains the same as the normal line width, thereby making it possible to avoid a situation where these wafers are discarded as defective ones.

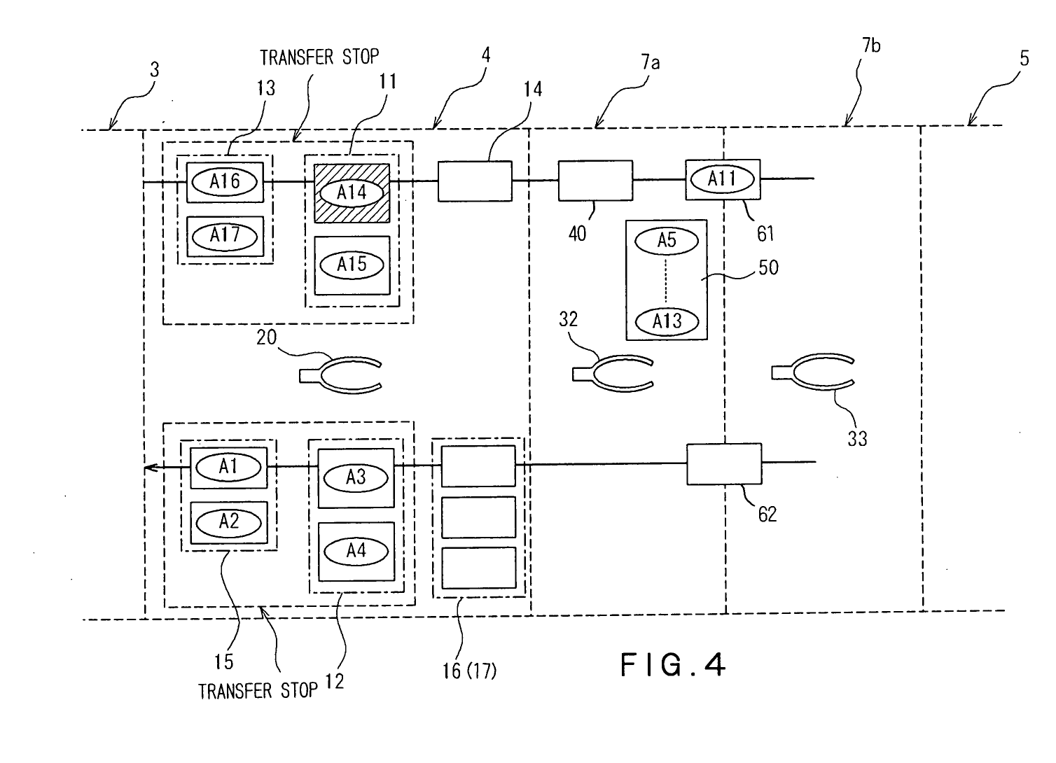

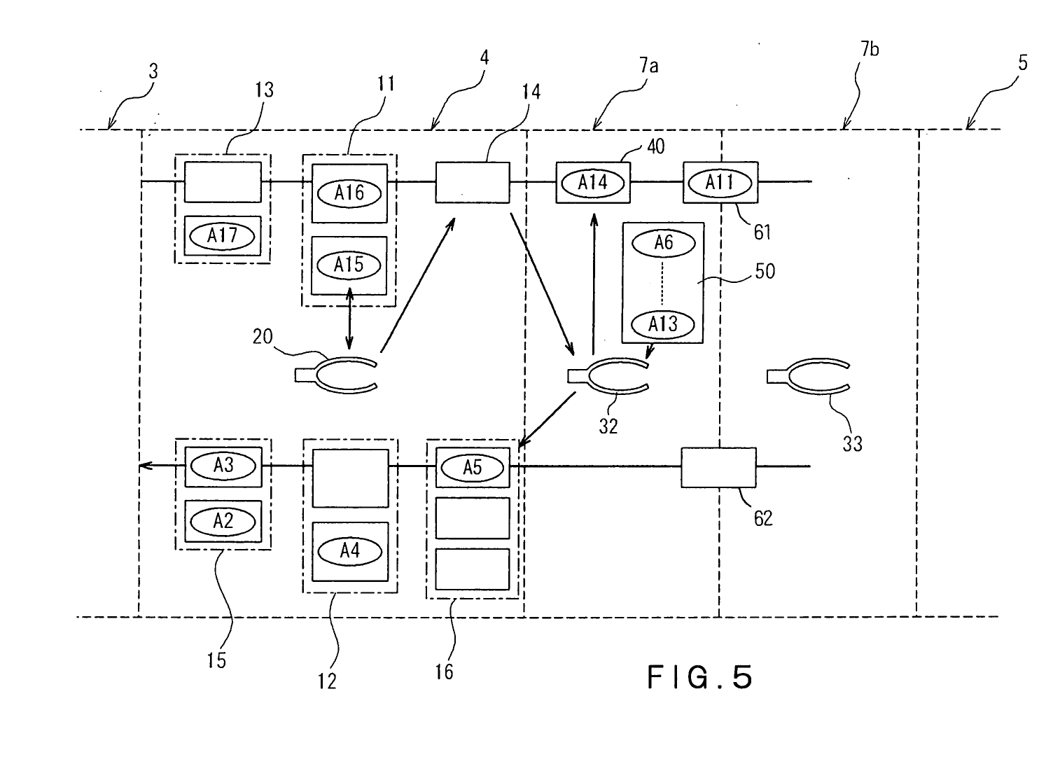

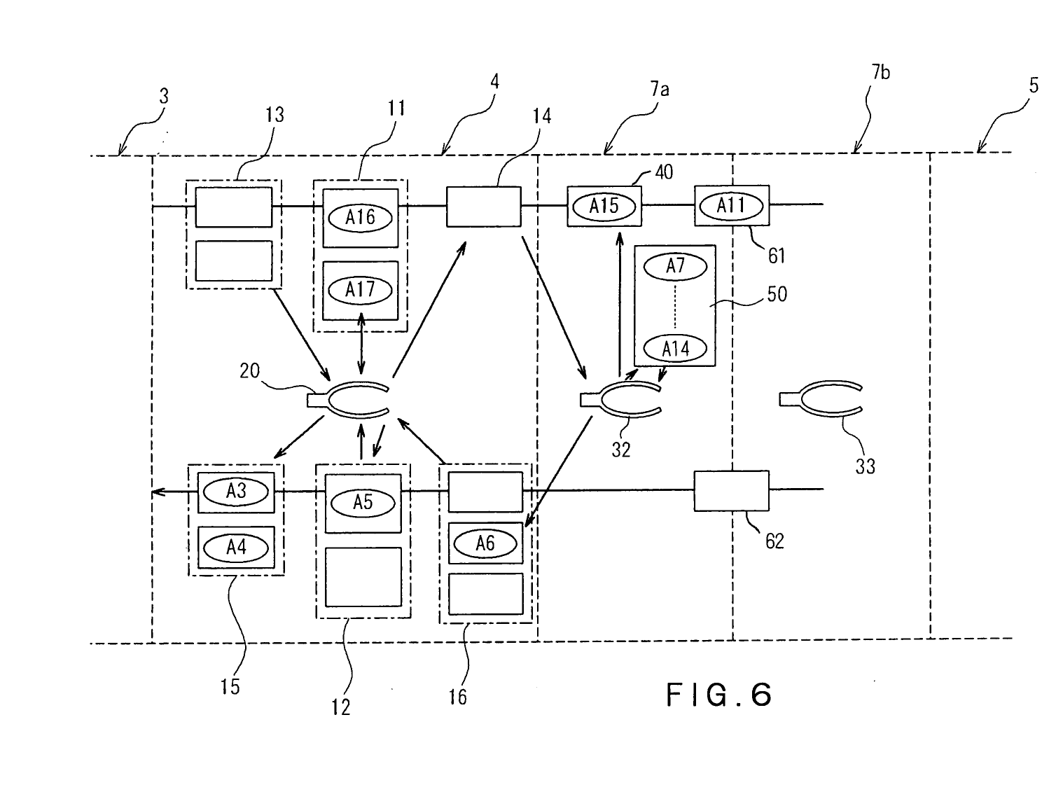

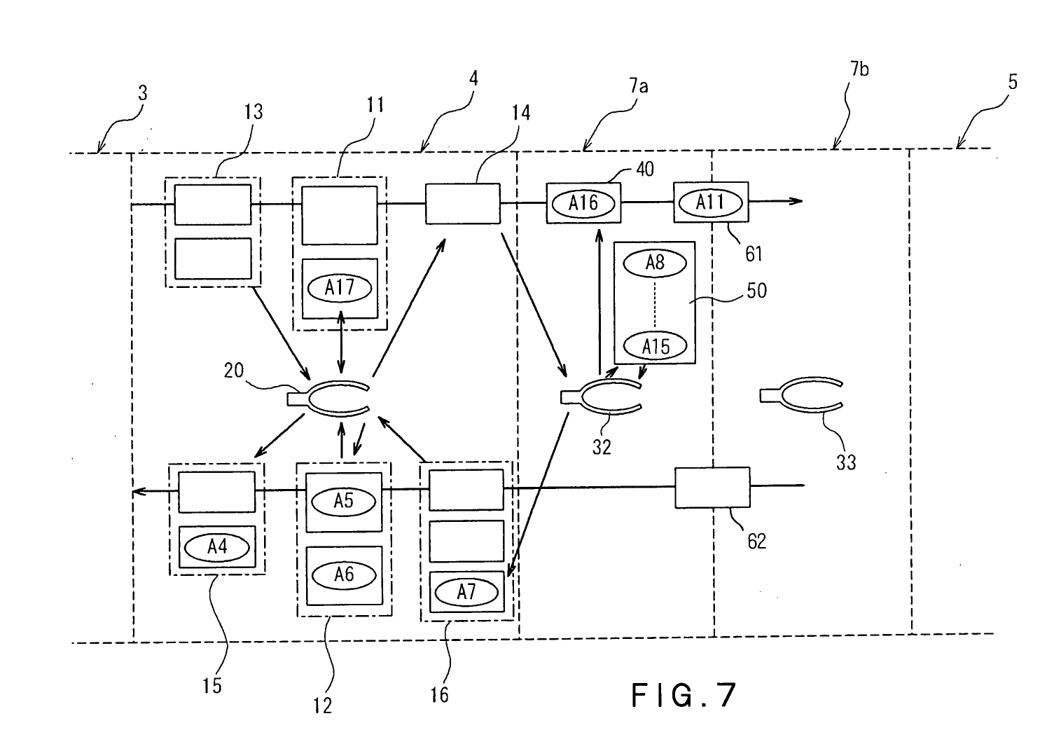

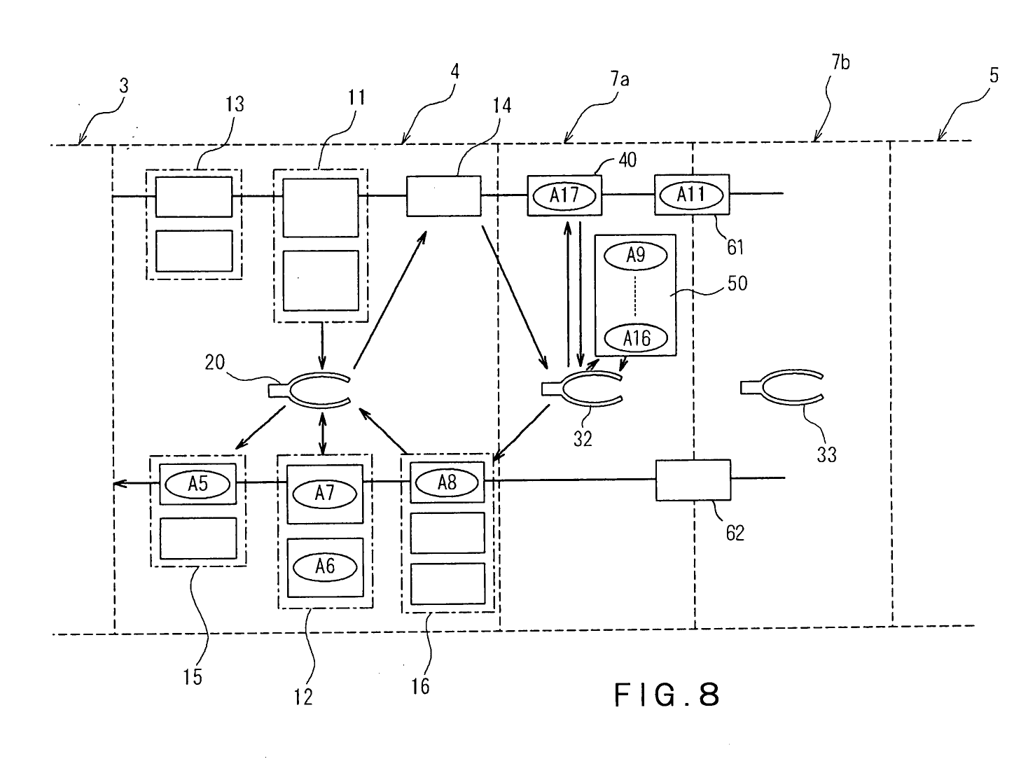

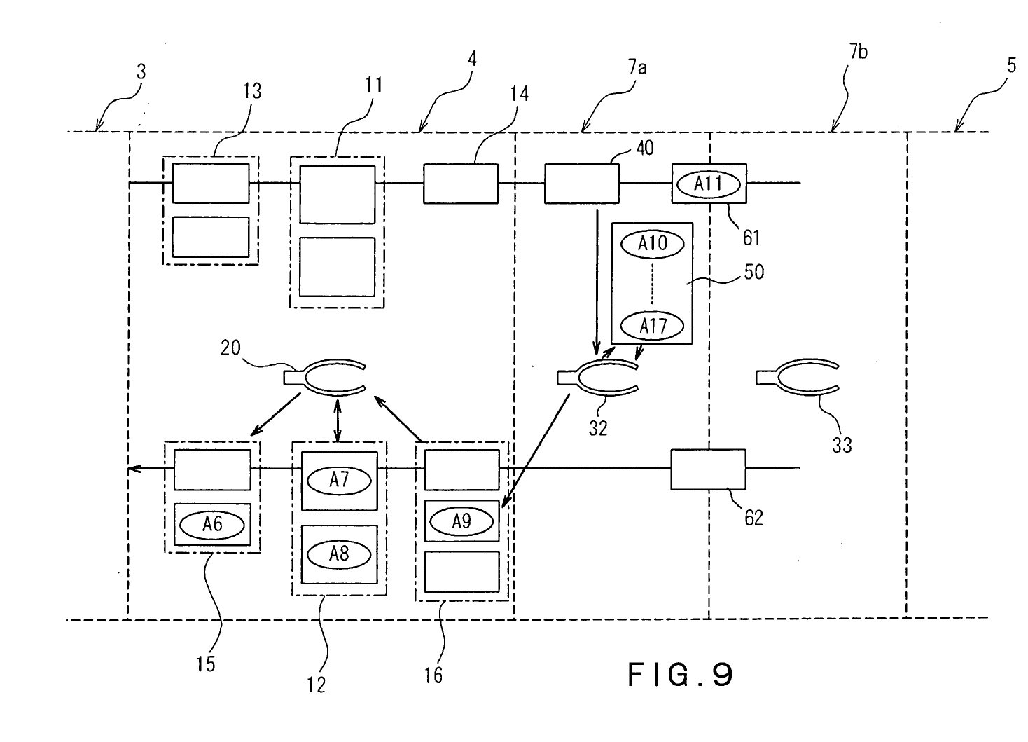

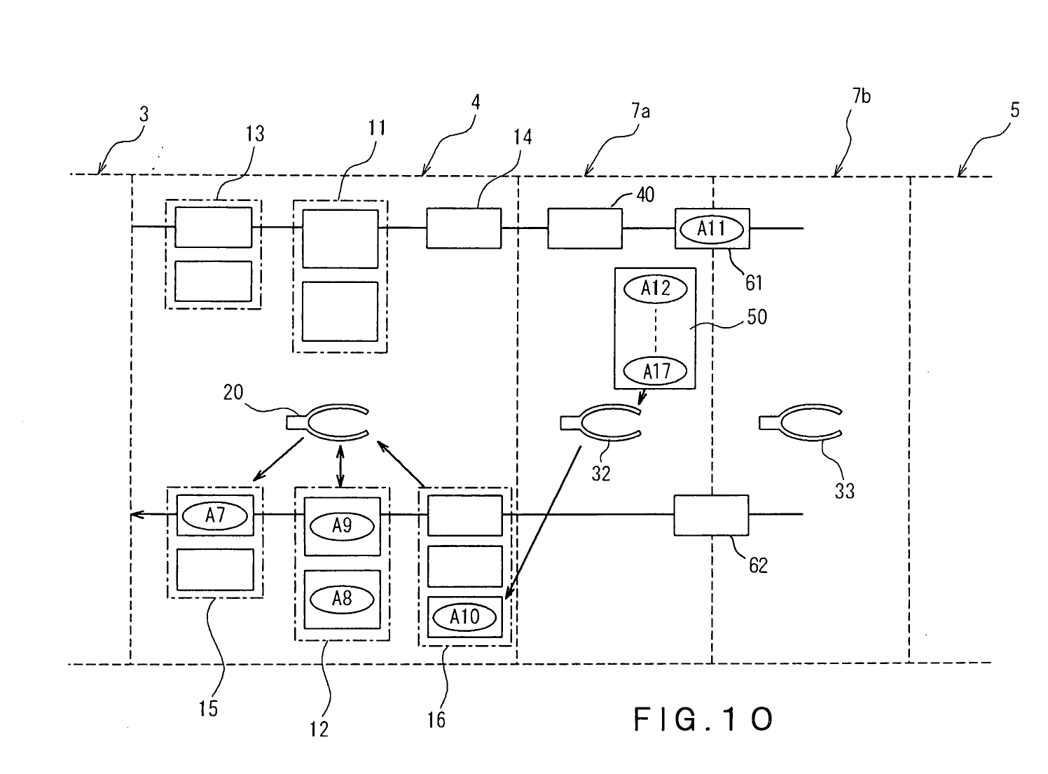

When the occurrence of a fault is detected, the controller 70 stops the loading of the wafers into the exposure apparatus 5 by the third transport module 33. In the illustrated embodiment, the loading of the wafer W (A11) existing in the first transfer module 61 into the exposure apparatus 5 is stopped, and the wafer W (A11) is left in the first transfer module 61. Here, it must be considered how the wafers positioned upstream of the first transfer module 61 in the pre-exposure substrate transport path should be handled. In the illustrated embodiment, wafer W (A13) is placed in the first hot plate module 14, i.e., a heating process module. It is not preferable that the resist be excessively heated even if it is still not exposed. It is therefore preferable that at least the wafer W (A13) be removed from the first hot plate module 14. Therefore, in this embodiment, the wafer W (A12) existing in the edge exposure module 40 is transported into the buffer module 50 by using the second transport module 32 after completion of the edge exposure process. Further, the wafer W (A13) existing in the first hot plate module 14 is transported to the edge exposure module 40 and subjected to the edge exposure process, and then transported into the buffer module 50 (see FIG. 4). Since the wafer W (A12) is placed in the edge exposure module 40, the wafer W (A12) remains intact even if it is left in the edge exposure module 40. Therefore, only wafer W (A13) may be loaded into the buffer module 50. However, if such a sequence is employed, the procedure for resuming the transport operation after the elimination of the fault is complicated. Consequently, this embodiment employs the procedure described above.

As mentioned earlier, the main transport arm 20 in this embodiment is configured to stop completely when a fault occurs in a process module (one of the coating modules 11 in this example) to and from which wafers are to be transferred by the main transport arm 20. Therefore, the transporting of wafers W (A15 to A17) not coated is stopped. Further, the loading of a wafer W (B1) of the next processing lot into the processing section 4 is stopped. Furthermore, the transporting of the developed wafers W (A1 to A4) is stopped.

When the fault of the coating module 11 is eliminated, the controller 70 receives a status signal from the coating module 11 and recognizes the restoration of the coating module 11. This causes the controller 70 to resume the transporting and processing of wafers W according to the following sequence.

The wafers W that have retreated in the buffer module 50 are handled as follows. The wafers W (A5 to A10) having been subjected to the PEB process are transported to the PEB module 16 by the transport module 32 in order corresponding to the order in which those wafers were subjected to the PEB process (in the order of A5, A6, A7, A8, A9, A10). Immediately after the wafers W (A5 to A10) are transferred to the PEB module 16, they are removed from the PEB module 16 by the main transport module 20 (in order to prevent them from being heated). More specifically, immediately after a wafer is placed on a wafer support pins for wafer transfer (not shown) that are provided in a hot plate (now shown) in the PEB module 16 and located in their ascent position, the wafer is transferred to the cooling module (17) built in the PEB module 16, and immediately thereafter is removed from the cooling module (17) by the main transport module 20. The wafer having been passed through the PEB module 16 is loaded into the developing module 12 by the main transport module 20 and developed in the developing module 12. If a high-precision temperature control module is furnished, the wafer is routed through the high-precision temperature control module before being loaded into the developing module 12. After completion of the development process, the wafer is transported and processed (subjected to a post-baking process) in accordance with a normal transport schedule and processing schedule, and eventually placed in cassette 2. The above sequence is obvious from FIGS. 5 to 12 (the greater the drawing number, the later the indicated state).

Since the main transport module 20 is configured to perform a “scheduled transport” operation as previously described, when the transporting operation in the post-exposure substrate transport path is started in the processing section 4, the transport operation in the pre-exposure substrate transport path within the processing section 4 is also started. However, the wafer W (A11) in the transfer module 61 cannot be immediately loaded into the exposure apparatus 5. This is because plural wafers having been subjected to the PEB process remain in the buffer module 50 at this time, and the transport schedule for the exposed wafer W (A11) must not conflict with the transport schedule for the last PEB-processed wafer A10 in the buffer module 50. Therefore, wafer W (A11) remains in the transfer module 61 for a while. However, with the above sequence, the wafers processed in the processing section 4 and positioned in the pre-exposure substrate transport path cannot move forward. In order to solve this problem, the wafers W (A14 to A17) in the pre-exposure substrate transport path are loaded into the buffer module 50 after completion of the edge exposure process and allowed to stand by in the buffer module 50 until the loading of the wafer (A11) into the exposure apparatus 5 starts. When the loading of the wafer W (A11) into the exposure apparatus 5 starts, wafers W (A14 to A17) are sequentially removed from the buffer module 50, are loaded into the transfer module 61, and are loaded into the exposure apparatus 5. The above sequence can be understood from FIGS. 5 to 12.

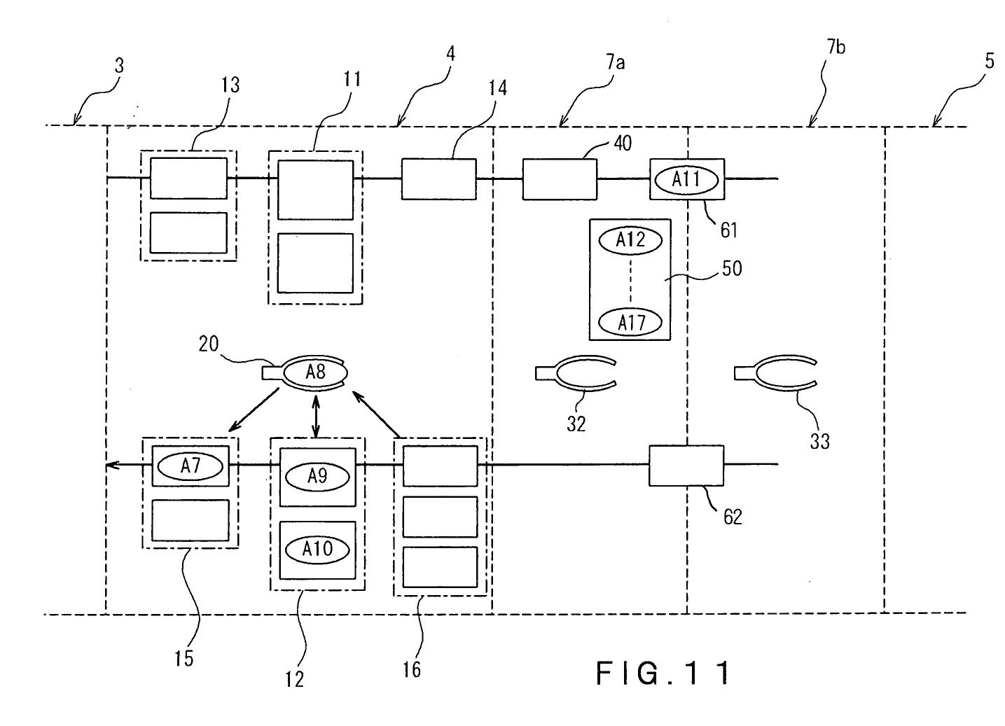

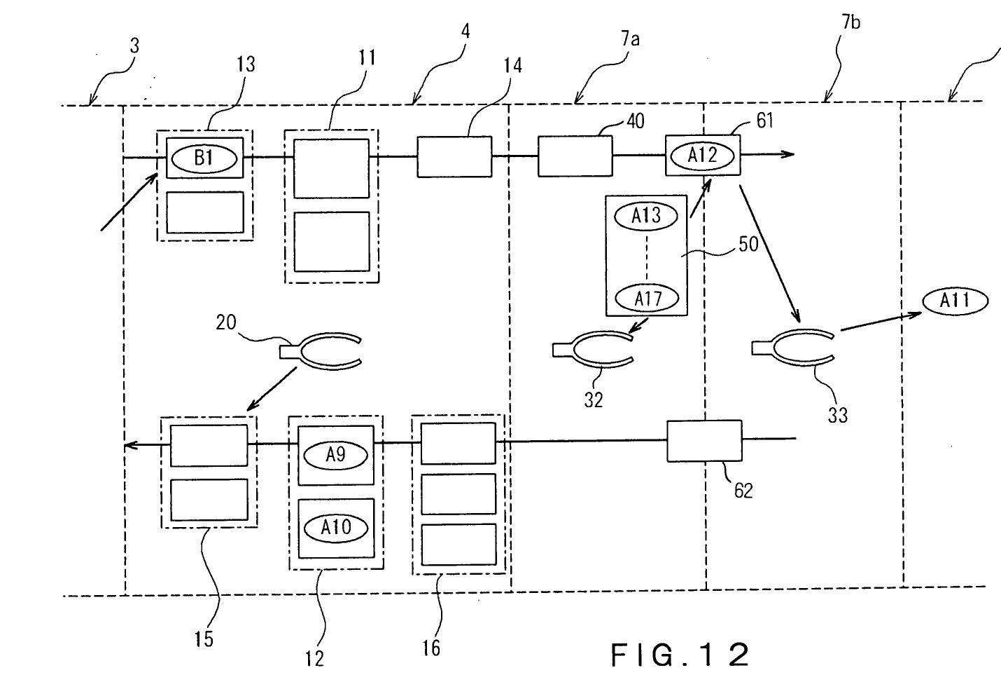

After that, a wafer W (B1) of the next production lot introduced into the processing section 4 and a normal operation is performed (see FIG. 12). The starting of the introduction of wafer W (B1) into the processing section 4 is timed to ensure that the transport schedule for wafer A17 existing in the buffer module 50 does not conflict with the transport schedule for the wafer W (B1).

In “Case 2” (where a fault occurs in the main transport module 20 of the processing section 4), the controller 70 performs substantially the same procedure as in “Case 3” based on a status signal received from the main transport module 20. Note that: in Case 2, if the main transport module 20 is not configured to perform the foregoing “scheduled transport” (but is configured such that the transport schedule can be changed at any time as needed), the wafer transport operation in the post-exposure substrate transport path by the main transport module 20 may be restarted first while keeping the wafer transport operation in the pre-exposure substrate transport path by the main transport module 20 stopped for a certain period of time after the main transport module 20 is restored. In this case, the capacity of the buffer module 50 may be reduced.

In “Case 1”, for example, in a case where a fault occurs in one of the developing modules 12, if the main transport module 20 configured to perform the foregoing “scheduled transport”, the controller 70 performs substantially the same procedure as that in the foregoing “Case 3” based on a status signal received from the developing module 12.

If, on the other hand, the transport schedule of the main transport module 20 can be changed at any time as needed, there is no need to completely stop the wafer transport operation in the post-exposure substrate transport path. However, if one of the two developing modules 12 becomes faulty, the number of wafers W that can flow in the post-exposure substrate transport path per unit time is reduced to about half. Also in this case, wafers W existing in a section from the exposure apparatus 5 to the PEB modules 16 cannot be transported downstream of the PEB module 16 as scheduled. Therefore, some of the wafers W existing in a section from the exposure apparatus 5 to the PEB modules 16 are loaded into the buffer module for standby after being subjected to the PEB process. In this instance, it is preferable that the transport and processing operations for the wafers in the pre-exposure substrate transport path be stopped. Alternatively, however, the transport and processing operations may be performed at a reduced pace.

As is obvious from the above description, according to the foregoing embodiment, the proper use of the buffer module 50 ensures that, in all the foregoing three cases of fault (Cases 1, 2, and 3), the time period from the exposure process completion to the PEB process completion for all the exposed wafers W (A5 to A10) can be maintained identical to that in the normal operation. Consequently, the line width of the resulting circuit pattern will not be adversely affected.

The present invention can be applied not only to a resist coating and developing system for wafers but also to that for LCD glass substrates.

1. A substrate transporting and processing apparatus that is connectable to an exposure apparatus and is configured to perform predetermined pre-exposure processes and predetermined post-exposure processes on substrates, said apparatus comprising:
a plurality of process modules adapted to perform the predetermined pre-exposure processes and the predetermined post-exposure processes, and including a process module for performing a post-exposure baking (PEB) process as one of the post-exposure processes;
a transport system including at least one transport module and configured to sequentially transport substrates to process modules for the pre-exposure process in accordance with a predetermined pre-exposure substrate transport path, transfer the substrates to the exposure apparatus, and sequentially transport exposed substrates to process modules for the post-exposure processes in accordance with a predetermined post-exposure substrate transport path;
a buffer module configured to contain a plurality of substrates and disposed so as to allow substrate to be transferred between the buffer module and the transport system; and
a controller configured to control operations of the plurality of process modules and the transport system in accordance with a predetermined substrate transport schedule and a predetermined substrate processing schedule, and configured to detect a fault that may occur in the plurality of process modules and the transport system,
wherein the controller is configured so that: when the controller detects a fault in the process module or the transport system that makes it impossible to transfer substrates, in accordance with the predetermined transport schedule, to a process module positioned downstream of the process module for performing the PEB process in the post-exposure substrate transport path, the controller controls the process module and the transport system so that exposed substrates are continuously subjected to processes to the PEB process included in the post-exposure processes, and so that at least part of the substrates having been subjected to the PEB process are loaded into the buffer module for temporary storage.

2. The substrate transporting and processing apparatus according to claim 1, wherein the controller is configured to stop loading of substrates positioned in the pre-exposure substrate transport path into the exposure apparatus, when the controller detects the fault.

3. The substrate transporting and processing apparatus according to claim 2, wherein the controller is configured to control the process modules and the transport system, when the controller detects the fault, so that: if substrates positioned in process modules in the pre-exposure substrate transport path include a substrate positioned in a process module which may become defective if the substrate is left in the process module, the substrate is loaded into the buffer module.

4. The substrate transporting and processing apparatus according to claim 1, wherein “the fault in the process module or the transport system, that makes it impossible to transfer substrates, in accordance with the predetermined transport schedule, to a process module positioned downstream of a process module for performing the PEB process in the post-exposure substrate transport path” is at least one of the following:
a fault that occurs in a process module positioned downstream of a process module that performs the PEB process in the post-exposure substrate transport path;
a fault that occurs in a transport module that performs loading or unloading of substrates into or from a process module positioned downstream of a process module for performing the PEB process in the post-exposure substrate transport path; and
a fault that occurs in a process module located in the pre-exposure substrate transport path, into and from which substrates are loaded and unloaded by a transport module that is also assigned to load and unload substrates into and from a process module positioned downstream of a process module for performing the PEB process in the post-exposure substrate transport path.

5. The substrate transporting and processing apparatus according to claim 1, wherein the controller is configured so that: when the controller detects the fault in the process module or the transport system that makes it impossible to transfer substrates to a process module positioned downstream of a process module for performing the PEB process in the post-exposure substrate transport path, the controller controls the process module and the transport system so that exposed substrates are continuously subjected to processes to the PEB process included in the post-exposure processes, and so that all the substrates having been subjected to the PEB process are loaded into the buffer module and are stored therein until the fault is eliminated.

6. The substrate transporting and processing apparatus according to claim 1, wherein each of the substrates to be subjected to the PEB process is a substrate whose surface is coated with a chemically-amplified resist having been exposed.

7. The substrate transporting and processing apparatus according to claim 1, wherein the PEB process comprises a heating process performed on a substrate having been exposed.

8. The substrate transporting and processing apparatus according to claim 1, wherein the PEB process comprises a heating process and a subsequent cooling process performed on a substrate having been exposed.

9. A fault management method for use in a substrate transporting and processing apparatus, the apparatus being connectable to an exposure apparatus and being configured to perform predetermined pre-exposure processes and predetermined post-exposure processes on substrates, the transporting and processing apparatus being provided with a plurality of process modules adapted to perform the predetermined pre-exposure processes and the predetermined post-exposure processes, and including a process module for performing a post-exposure baking (PEB) process as one of the post-exposure processes, and the transporting and processing apparatus also being provided with a transport system including at least one transport module and configured to sequentially transport substrates to process modules for the pre-exposure process in accordance with a predetermined pre-exposure substrate transport path, transfer the substrates to the exposure apparatus, and sequentially transport exposed substrates to process modules for the post-exposure processes in accordance with a predetermined post-exposure substrate transport path, said method comprising the steps of:
detecting a fault in the process module or the transport system that makes it impossible to transfer substrates, in accordance with the predetermined transport schedule, to a process module positioned downstream of a process module for performing the PEB process in the post-exposure substrate transport path; and
upon detection of the fault, continuously performing processes to the PEB process included in the post-exposure processes to exposed substrates, and loading at least part of the substrates having been subjected to the PEB process into the buffer module for temporary storage.

10. The method according to claim 9, further comprising a step of stopping loading of substrates in the pre-exposure substrate transport path into the exposure apparatus when the fault is detected.

11. The method according to claim 10, further comprising a step of, if substrates positioned in process modules in the pre-exposure substrate transport path include a substrate positioned in a process module which may become defective if the substrate is left in the process module, loading the substrate into the buffer module.

12. The method according to claim 9, wherein “the fault in the process module or the transport system, that makes it impossible to transfer substrates, in accordance with the predetermined transport schedule, to a process module positioned downstream of a process module for performing the PEB process in the post-exposure substrate transport path” is at least one of the following:
a fault that occurs in a process module positioned downstream of a process module that performs the PEB process in the post-exposure substrate transport path;
a fault that occurs in a transport module that performs loading or unloading of substrates into or from a process module positioned downstream of a process module for performing the PEB process in the post-exposure substrate transport path; and
a fault that occurs in a process module located in the pre-exposure substrate transport path, into and from which substrates are loaded and unloaded by a transport module that is also assigned to load and unload substrates into and from a process module positioned downstream of a process module for performing the PEB process in the post-exposure substrate transport path.

13. The method according to claim 9, wherein, if the detected fault is a fault in the process modules or the transport systems that makes it impossible to transport a substrate to a process module positioned downstream of a process module for performing the PEB process in the post-exposure substrate transport path, exposed substrates are continuously subjected to processes to the PEB process included in the post-exposure processes, and all the substrates having been subjected to the PEB process are loaded into the buffer module and are stored therein until the fault is eliminated.

14. The method according to claim 9, wherein each of the substrates to be subjected to the PEB process is a substrate whose surface is coated with a chemically-amplified resist having been exposed.

15. The method according to claim 9, wherein the PEB process comprises a heating process performed on a substrate having been exposed.

16. The method according to claim 9, wherein the PEB process comprises a heating process and a subsequent cooling process performed on a substrate having been exposed.

17. A storage medium storing a computer-readable fault management program for executing a fault management method for use in a substrate transporting and processing apparatus, the apparatus being connectable to an exposure apparatus and being configured to perform predetermined pre-exposure processes and predetermined post-exposure processes on substrates, the transporting and processing apparatus being provided with a plurality of process modules adapted to perform the predetermined pre-exposure processes and the predetermined post-exposure processes, and including a process module for performing a post-exposure baking (PEB) process as one of the post-exposure processes, the transporting and processing apparatus also being provided with a transport system including at least one transport module and configured to sequentially transport substrates to process modules for the pre-exposure process in accordance with a predetermined pre-exposure substrate transport path, transfer the substrates to the exposure apparatus, and sequentially transport exposed substrates to process modules for the post-exposure processes in accordance with a predetermined post-exposure substrate transport path, the transporting and processing apparatus also being provided with a control computer that controls the operations of the plurality of process modules and the transport system, wherein upon execution of the fault management program, the control computer controls the substrate transporting and processing apparatus to execute the fault management method according to claim 9.
